(19) United States
(12) Patent Application Publication
(10) Pub. No.: US 2017/0009487 A1
(43) Pub. Date: Jan. 12, 2017

(54) RECEIVER MECHANISM FOR DOOR LOCK DEVICE

(71) Applicant: Gianni Industries Inc., Taipei (TW)

(72) Inventor: Chih Chung CHANG, Taipei (TW)

(21) Appl. No.: 14/792,734

(22) Filed: Jul. 7, 2015

(51) Int. Cl. E05B 15/02; E05C 1/08

(52) U.S. Cl. CPC E05B 15/024; E05C 1/08

(57) ABSTRACT

A door lock device includes a receiver mechanism includes a housing having a chamber for engaging with a casing which has a compartment for engaging with a deadbolt of a lock mechanism, a fastener secures the casing to the housing at a selected position after the casing has been adjusted relative to the housing, a block is engaged in the housing, and a fastener is engaged with the block for securing the block to the housing at a selected position after the block has been adjusted relative to the housing, such that the casing and the block are adjustable relative to the housing to any selected position for fitting and engaging with various kinds of door lock devices.

### BACKGROUND OF THE INVENTION

1. Field of the Invention

The present invention relates to a door lock device, and more particularly to a door lock device including an adjustable receiver device or mechanism for selectively and adjustably engaging with the deadbolt or latch bolt or locking stud and for allowing the door lock device to be easily and quickly and readily attached or mounted or assembled into the door panels.

2. Description of the Prior Art

Various kinds of typical door lock devices have been developed and provided for attaching or mounting or assembling into the door panels and for latching or locking the door panels together, and normally comprise a lock plate or receiver device or mechanism attached or mounted or assembled into one of the door panels, and a lock or latch device or mechanism attached or mounted or assembled into the other door panel and having a deadbolt or latch bolt or locking stud for engaging with the lock plate or receiver device or mechanism and for selectively latching or locking the door panels together.

For example, U.S. Pat. No. 5,386,713 to Wilson, U.S. Pat. No. 5,531,086 to Bryant, U.S. Pat. No. 5,626,039 to Solari et al., U.S. Pat. No. 5,791,179 to Brask, U.S. Pat. No. 5,876,073 to Geringer et al., U.S. Pat. No. 6,079,755 to Chang, U.S. Pat. No. 6,974,163 to Peng et al., U.S. Pat. No. 7,469,564 to Shaw, and U.S. Pat. No. 8,033,583 to Chang disclose several of the typical door lock devices each also comprising a lock plate or receiver device or mechanism attached or mounted or assembled into one of the door panels, and a lock or latch device or mechanism attached or mounted or assembled into the other door panel and having a deadbolt or latch bolt or locking stud for engaging with the lock plate or receiver device or mechanism and for selectively latching or locking the door panels together.

However, the deadbolts or latch bolts or locking studs of the typical door lock devices normally comprise a predetermined shape or structure or configuration that may not be adjusted relative to the outer receptacle and also may not be adjusted relative to the lock plate or receiver device or mechanism, such that only the selected and predetermined lock plate or receiver device or mechanism may be used and attached or mounted or assembled into the door panel for engaging with the deadbolts or latch bolts or locking studs of the typical door lock devices, but may not be used for engaging with the other deadbolts or latch bolts or locking studs of the other door lock devices.

The present invention has arisen to mitigate and/or obviate the afore-described disadvantages of the conventional receiver devices for door lock devices.

### SUMMARY OF THE INVENTION

The primary objective of the present invention is to provide a door lock device including an adjustable receiver device or mechanism for selectively and adjustably engaging with the deadbolt or latch bolt or locking stud and for allowing the door lock device to be easily and quickly and readily attached or mounted or assembled into the door panels.

In accordance with one aspect of the invention, there is provided a door lock device comprising a lock mechanism including a deadbolt, and a receiver mechanism including a housing having a chamber formed therein, a casing slidably engaged in the chamber of the housing and having a compartment formed in the casing for selectively receiving and engaging with the deadbolt, a first fastener engaged through the housing and engaged with the casing for securing the casing to the housing at a selected position after the casing has been adjusted relative to the housing, a block slidably engaged in the chamber of the housing, and a second fastener engaged through the housing and engaged with the block for securing the block to the housing at a selected position after the block has been adjusted relative to the housing and thus for allowing the receiver mechanism to be fitted and engaged with various kinds of door lock devices.

The housing includes a side panel having a groove formed in the side panel of the housing and communicating with the chamber of the housing, and includes a guide rail provided in the housing, and the casing includes an engaging channel formed therein for slidably engaging with the guide rail of the housing and for guiding and limiting the casing to move and adjust relative to the housing. The guide rail of the housing is preferably formed in the side panel of the housing. The first and the second fasteners are slidably engaged in the groove of the housing.

Alternatively, the casing may include an engaging flap formed or provided therein and slidably engaged with the guide rail of the housing for guiding and limiting the casing to slide or move and adjust relative to the housing. The block may also include an engaging flap slidably engaged with the guide rail of the housing for guiding and limiting the block to move and adjust relative to the housing and for preventing the block and/or the casing from being disengaged or separated from the housing.

The block may also include an engaging channel formed therein for slidably engaging with the guide rail of the housing and for guiding and limiting the block to move and adjust relative to the housing. The lock mechanism includes a locking rod for selectively engaging with the block of the receiver mechanism. The lock mechanism includes a latch bolt for selectively engaging with the housing of the receiver mechanism where the casing and the block are not located, or the housing may include a space formed therein where the casing and the block are not located, for selectively receiving and engaging with the latch bolt.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a door lock device in accordance with the present invention for a door facility;

FIG. 2 is a partial plan schematic view of the door facility having the door lock device;

FIG. 3 is a partial exploded view of the door lock device;

FIG. 4 is another partial exploded view of the door lock device;

FIG. 5 is another partial exploded view similar to FIG. 1, illustrating the operation of the door lock device;

FIG. 6 is a partial plan schematic view similar to FIG. 2, illustrating the operation of the door lock device as shown in FIG. 5;

FIGS. 7, 8 are further partial exploded views similar to FIGS. 3 and 4, illustrating the operation of the door lock device as shown in FIGS. 5-6;

FIG. 9 is another partial exploded view similar to FIGS. 1 and 5, illustrating the operation of the door lock device;

FIG. 10 is a partial plan schematic view similar to FIGS. 2 and 6, illustrating the operation of the door lock device as shown in FIG. 9; and

FIGS. 11, 12 are further partial exploded views similar to FIGS. 3-4 and 7-8, illustrating the operation of the door lock device as shown in FIGS. 9-10.

### DETAILED DESCRIPTION OF THE PREFERRED EMBODIMENT

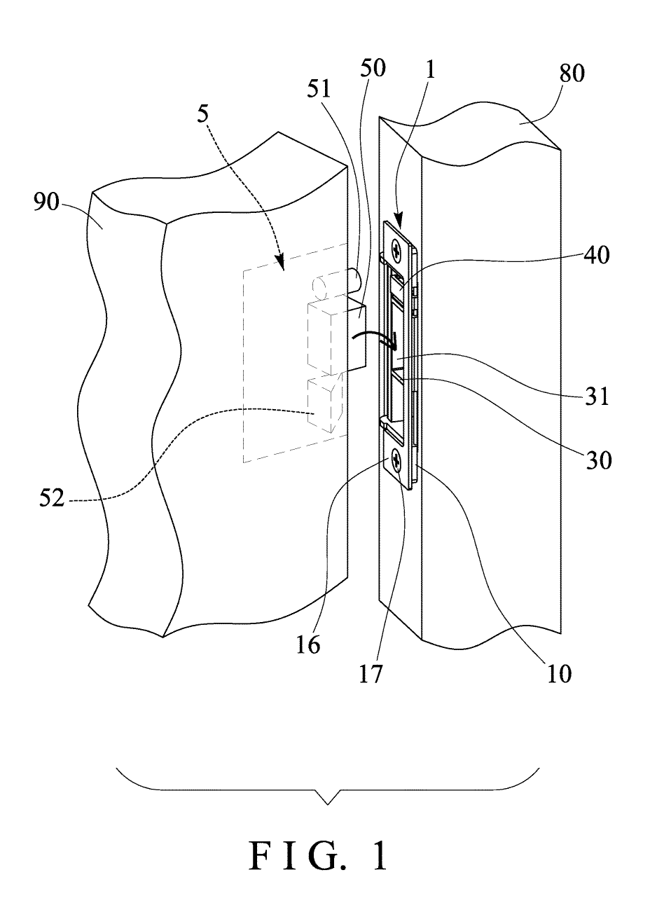

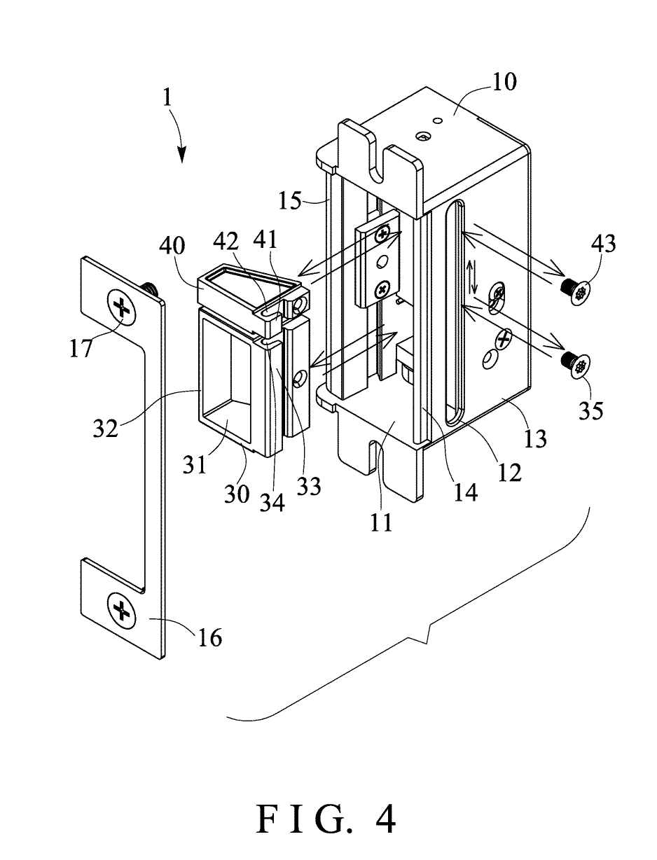

Referring to the drawings, and initially to FIGS. 1-4, a door lock device in accordance with the present invention comprises a lock plate or receiver device or mechanism 1 attached or mounted or assembled into one of the door panels 80, and a lock or latch device or mechanism 5 attached or mounted or assembled into the other door panel 90 and having a deadbolt 50 and/or a locking stud or rod 51 and/or a latch bolt 52 for engaging with the lock plate or receiver mechanism 1 and for selectively latching or locking the door panels 80, 90 together, in which the lock mechanism 5 may be selected from various kinds of typical door lock devices, and the above-described structure or configuration for the lock mechanism 5 is typical and is not related to the present invention and will not be described in further details.

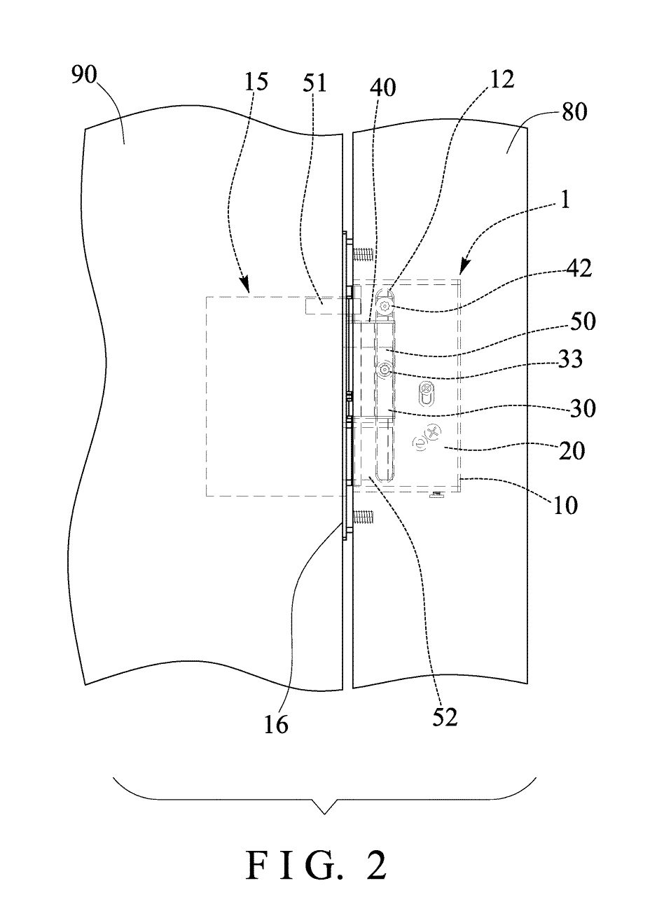

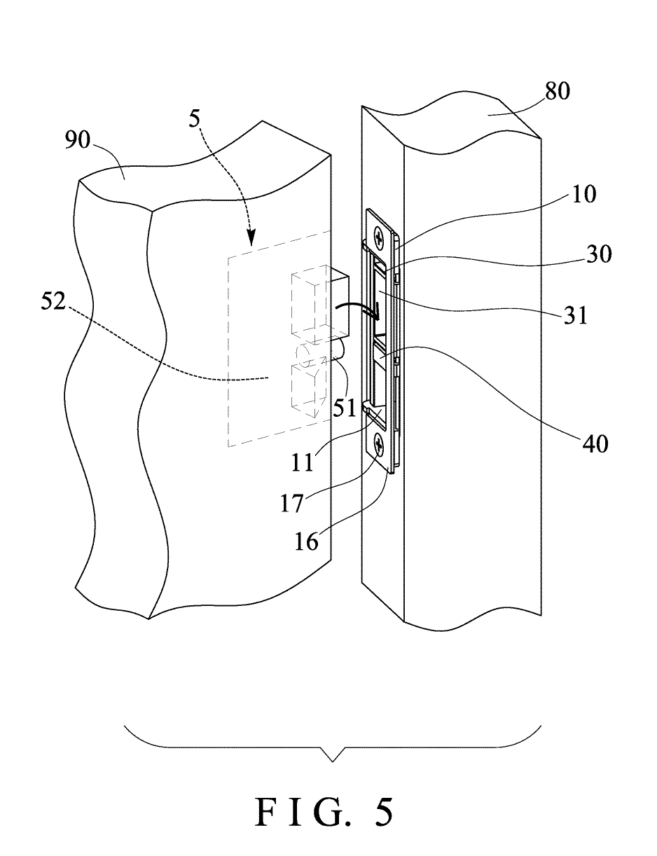

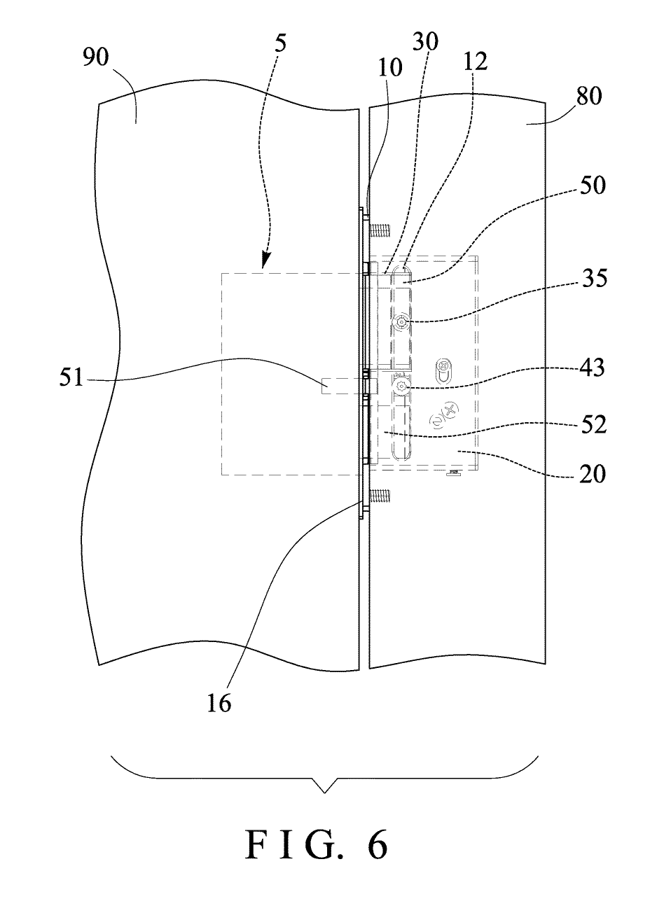

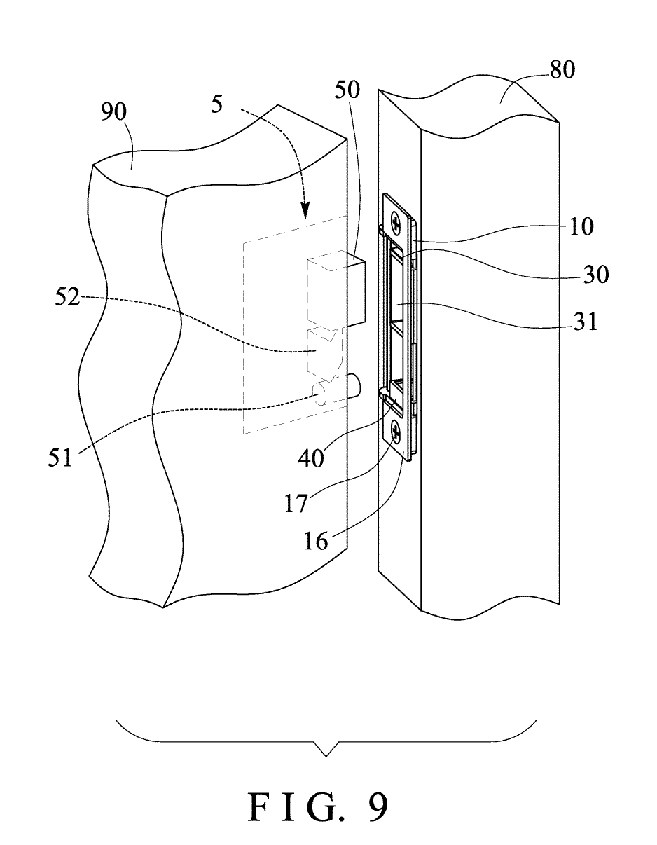

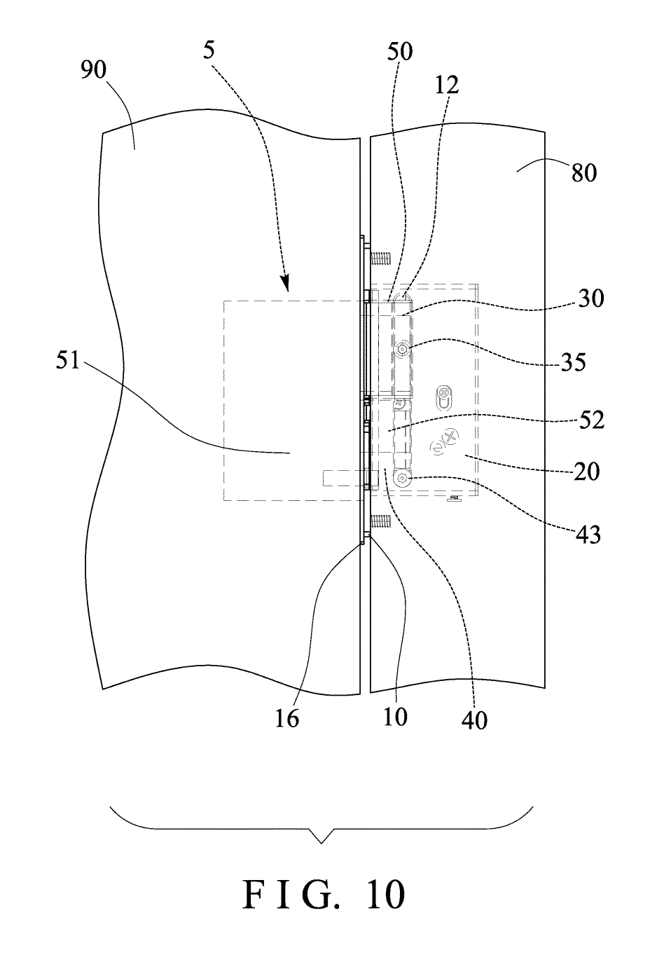

The deadbolt 50 and/or the locking rod 51 and/or the latch bolt 52 of the lock mechanism 5 are extendible out of the lock mechanism 5 and the door panel 90 for selectively engaging with the lock plate or receiver mechanism 1 that is assembled into the door panel 80, in which the deadbolt 50 is shown to include a square or rectangular cross section, the locking rod 51 is shown to include a circular cross section, and the latch bolt 52 is shown to include a triangular cross section, however, the deadbolt 50 and/or the locking rod 51 and/or the latch bolt 52 of the lock mechanism 5 may also be selected from the other shapes or structures or configurations. For example, the deadbolt 50 may be disposed above the safety pin or locking rod 51 and the latch bolt 52 (FIGS. 5-6, 9-10), or disposed between the locking rod 51 and the latch bolt 52 (FIGS. 1-2), or the like, the locking rod 51 may be disposed above the deadbolt 50 and the latch bolt 52 (FIGS. 1-2), or below the deadbolt 50 and the latch bolt 52 (FIGS. 9-10), or between the deadbolt 50 and the latch bolt 52 (FIGS. 5-6).

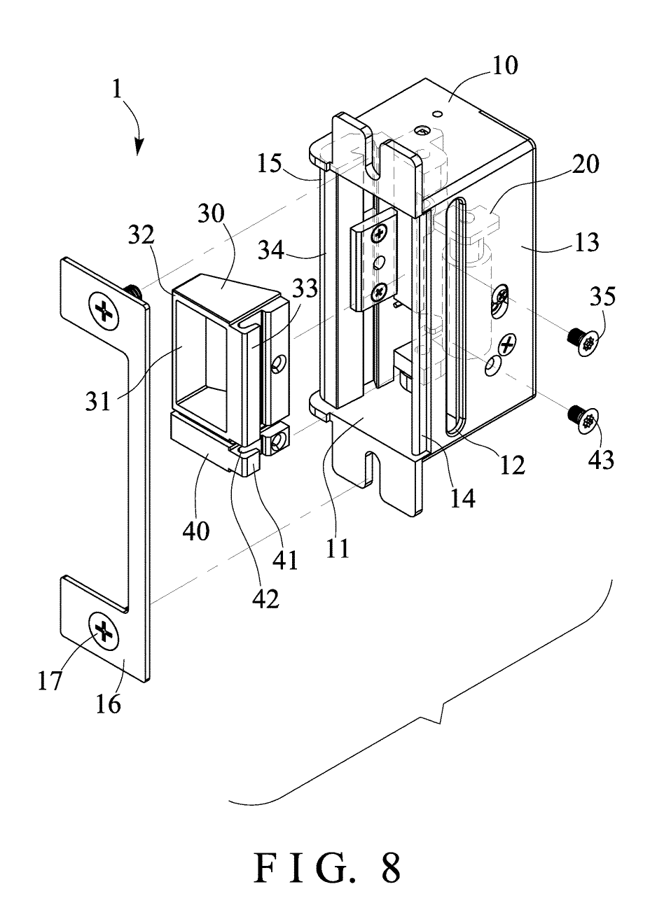

As shown in FIGS. 1-4, the lock plate or receiver mechanism 1 includes a receptacle or housing 10 having a compartment or chamber 11 formed therein for receiving or engaging with a solenoid mechanism 20 (FIGS. 2, 8) or the like therein, the solenoid mechanism 20 is also not related to the present invention and will not be described in further details. The housing 10 includes an oblong hole or groove 12 formed or provided in one of the side panels 13 of the housing 10 and communicating with the chamber 11 of the housing 10, and includes a guide track or rail 14 formed or provided therein, such as formed in the side panel 13 at the front portion 15 of the housing 10. A cap or cover 16 may be selectively attached or mounted or secured to the front portion 15 of the housing 10 with latches or fasteners 17 for partially blocking or shielding the front portion 15 of the housing 10 and for anchoring or retaining or positioning the parts or elements within the chamber 11 of the housing 10.

The receiver mechanism 1 further includes a casing 30 slidably received or engaged in the chamber 11 of the housing 10 and having a chamber or compartment 31 formed therein and formed or defined by an outer peripheral wall or frame 32 for receiving or engaging with the deadbolt 50, and the outer peripheral frame 32 and/or the compartment 31 of the casing 30 include a square or rectangular shape or structure or configuration similar or identical to that of the deadbolt 50 for suitably receiving or engaging with the deadbolt 50, and the casing 30 includes an engaging flap 33 and/or an engaging channel 34 formed therein for slidably receiving or engaging with the guide rail 14 of the housing 10 and for guiding and limiting the casing 30 to slide or move or adjust up and down relative to the housing 10.

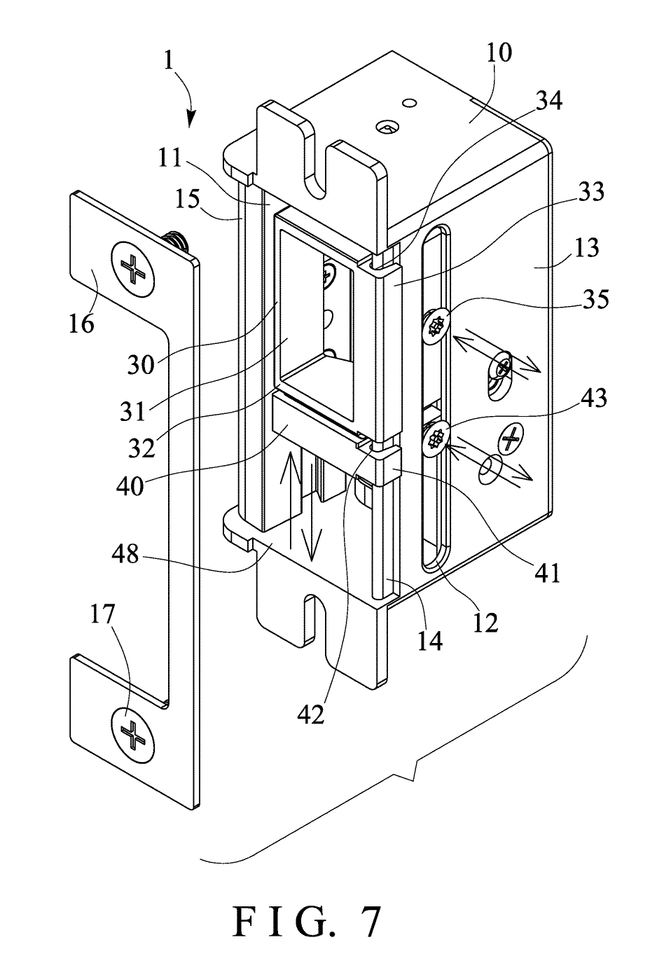

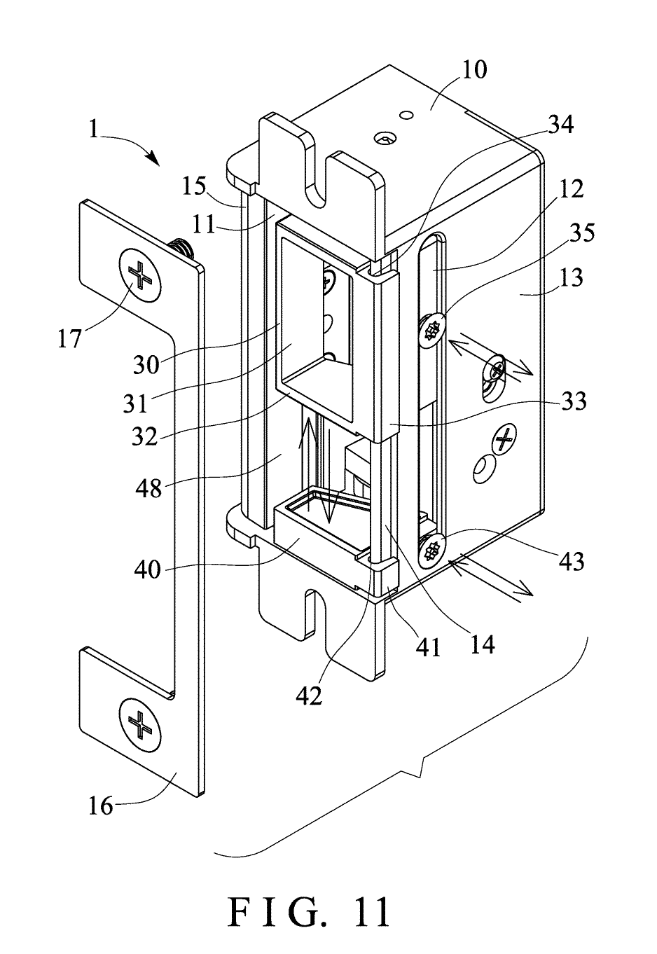

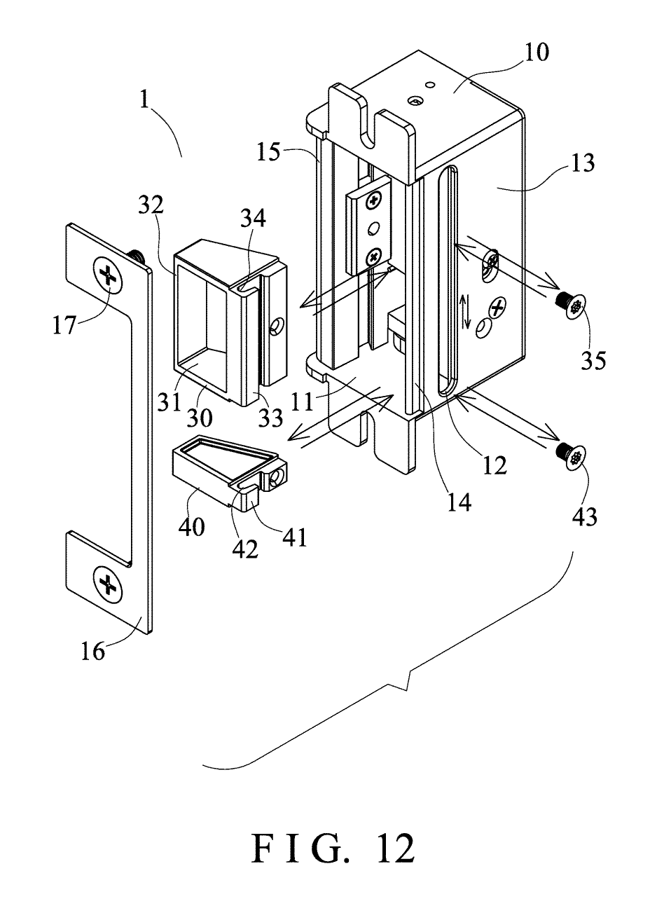

A first screw or bolt or fastener 35 or the like may be engaged into or through the groove 12 of the housing 10 and engaged with the casing 30 for locking or securing the casing 30 to the housing 10 at the selected or required position or location after the casing 30 has been adjusted up and down relative to the housing 10. For example, the casing 30 may be locked or secured to the housing 10 at the upper portion of the housing 10 (FIGS. 5-12), or at the middle portion of the housing 10 (FIGS. 1-4) for selectively engaging with the deadbolt 50. The receiver mechanism 1 further includes a stop or block 40 also slidably received or engaged in the chamber 11 of the housing 10 and having an engaging flap 41 and/or an engaging channel 42 formed therein for slidably receiving or engaging with the guide rail 14 of the housing 10 and for guiding and limiting the block 40 to slide or move or adjust up and down relative to the housing 10.

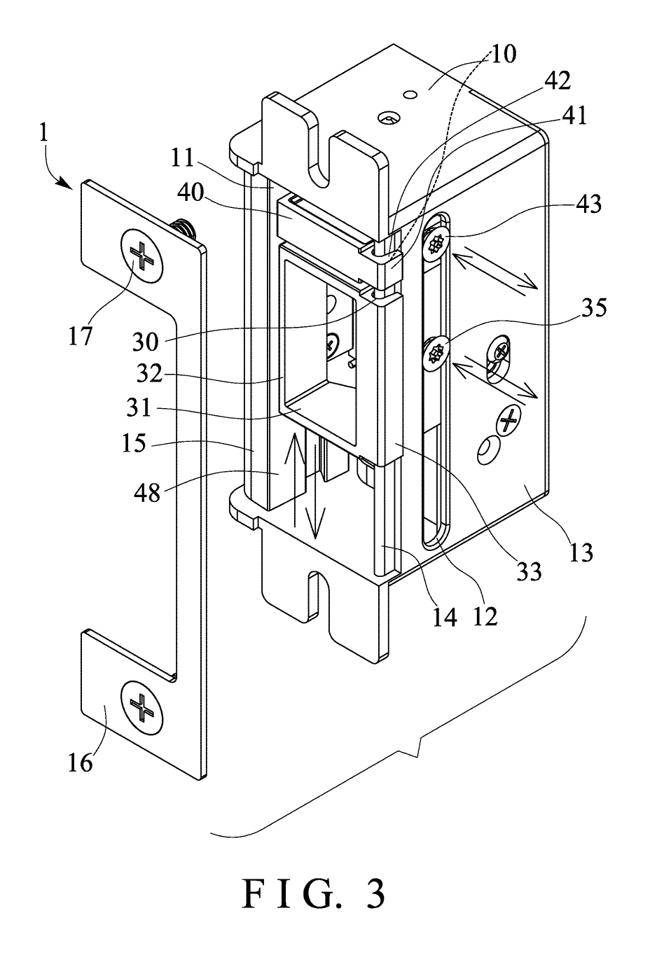

Another or a second screw or bolt or fastener 43 or the like may be engaged into or through the groove 12 of the housing 10 and engaged with the block 40 for locking or securing the block 40 to the housing 10 at the selected or required position or location after the block 40 has been adjusted up and down relative to the housing 10. For example, the block 40 may be locked or secured to the housing 10 at the upper portion of the housing 10 (FIGS. 1-4), or at the middle or intermediate portion of the housing 10 (FIGS. 5-8), or at the lower portion of the housing 10 (FIGS. 9-12) for selectively contacting or engaging with the locking rod 51. After the casing 30 and the block 40 have been locked or secured to the housing 10 at the selected or required position or location, a space 48 may be formed in the housing 10 (FIGS. 3, 7, 11) where the casing 30 and the block 40 are not located for receiving or engaging with the latch bolt 52.

In operation, as shown in FIGS. 1-2, 5-6, 9-10, when a lock mechanism 5 has been selected and predetermined, the deadbolt 50 and/or the locking rod 51 and/or the latch bolt 52 of the lock mechanism 5 may also be selected and predetermined and may not be adjusted relative to the lock mechanism 5, the casing 30 and the block 40 may be adjusted relative to the housing 10 to any selected or required position or location where the casing 30 is aligned with the deadbolt 50 for suitably receiving or engaging with the deadbolt 50, and the block 40 may be adjusted relative to the housing 10 to any selected or required position or location where the block 40 is aligned with the locking rod 51 for suitably engaging with the locking rod 51. The space 48 that is formed in the housing 10 (FIGS. 3, 7, 11) where the casing 30 and the block 40 are not located may thus be provided for receiving or engaging with the latch bolt 52, such that the receiver mechanism 1 may be selected and fitted for various kinds of door lock devices.

Accordingly, the door lock device in accordance with the present invention includes an adjustable receiver device or mechanism for selectively and adjustably engaging with the deadbolt or latch bolt or locking stud and for allowing the door lock device to be easily and quickly and readily attached or mounted or assembled into the door panels.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A door lock device comprising:
a lock mechanism including a deadbolt, and
a receiver mechanism including a housing having a chamber formed therein,
a casing slidably engaged in said chamber of said housing and having a compartment formed in said casing for selectively receiving and engaging with said deadbolt,
a first fastener engaged through said housing and engaged with said casing for securing said casing to said housing at a selected position after said casing has been adjusted relative to said housing,
a block slidably engaged in said chamber of said housing, and
a second fastener engaged through said housing and engaged with said block for securing said block to said housing at a selected position after said block has been adjusted relative to said housing.

2. The door lock device as claimed in claim 1, wherein said housing includes a side panel having a groove formed in said side panel of said housing and communicating with said chamber of said housing, and includes a guide rail provided in said housing, and said casing includes a channel formed therein for slidably engaging with said guide rail of said housing and for guiding and limiting said casing to move and adjust relative to said housing.

3. The door lock device as claimed in claim 2, wherein said guide rail of said housing is formed in said side panel of said housing.

4. The door lock device as claimed in claim 1, wherein said housing includes a guide rail, and said casing includes a flap slidably engaged with said guide rail of said housing for guiding and limiting said casing to move and adjust relative to said housing.

5. The door lock device as claimed in claim 1, wherein said housing includes a guide rail, and said block includes a flap slidably engaged with said guide rail of said housing for guiding and limiting said block to move and adjust relative to said housing.

6. The door lock device as claimed in claim 1, wherein said housing includes a side panel having a groove formed in said side panel of said housing and communicating with said chamber of said housing, and includes a guide rail provided in said housing, and said block includes a channel formed therein for slidably engaging with said guide rail of said housing and for guiding and limiting said block to move and adjust relative to said housing.

7. The door lock device as claimed in claim 1, wherein said lock mechanism includes a locking rod for selectively engaging with said block.

8. The door lock device as claimed in claim 1, wherein said lock mechanism includes a latch bolt for selectively engaging with said receiver mechanism.
